(19) United States
(12) Patent Application Publication
(10) Pub. No.: US 2012/0154510 A1
(43) Pub. Date: Jun. 21, 2012

(54) Smart Camera for Virtual Conferences

(75) Inventors: Christian F. Huitema, Clyde Hill, WA (US); Duane B. Molitor, Redmond, WA (US); Maria R. Kawal, Seattle, WA (US); Royal D. Winchester, Sammamish, WA (US)

(73) Assignee: MICROSOFT CORPORATION, Redmond, WA (US)

(21) Appl. No.: 12/972,214

(22) Filed: Dec. 17, 2010

(51) Int. Cl. H04N 7/15; H04N 5/225

(52) U.S. Cl. 348/14.03; 348/207.1; 348/E05.024; 348/E07.083

(57) ABSTRACT

The subject disclosure is directed towards a video-related system including smart camera algorithms that select and control camera views (camera, point of view and framing selections) to provide a more desirable viewing experience of a conference or the like, e.g., emulating an actual technician's selected views. The system uses various inputs, such as to determine participants' activities (a current speaker, movements, and other participant input) and the history of the conference (how long the same view has been shown). The system may be used with conventional video applications, or “virtual” conferences in which users are represented by avatars.

### BACKGROUND

Virtual conferences, including video conferences, need to use a relatively small display surface such as a computer monitor or television screen to provide participants with a view of the remote participants. Managing the output to that display surface is based upon making choices of what to show each participant.

In a professional environment, skilled technicians (e.g., one or more cameramen and possibly a director) are able to manage the camera or cameras for a desirable production. However, most virtual conferences do not use such professionals, and have to make do with automated systems. Most existing teleconference systems solve the problem of what to show at what time with very simple systems, using either static views, or simple voice-activated switching that shows the person currently talking. Such simple systems provide a poor user experience relative to a professionally managed live and/or recorded presentation.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which smart camera algorithms apply rules and data to make artificially intelligent selections of camera views for presenting to participant users, and output video data in a way that resembles selection decisions made by professional video technicians. In one aspect, video data captured from participant cameras is received, and provided to a smart camera algorithm. The algorithm includes a set of rules for selecting a view, including camera and framing selection. Display data corresponding to the selected view is output to a display, and the process repeated to provide a representative video clip corresponding to some of the original video frames that were captured.

In one aspect, the selected view is chosen based upon participant activity and history data. For example, a prior view, which may be selected based upon participant activity (e.g., a participant speaking, emoting by selecting special effects, moving, gesturing, entering an environment, or exiting an environment) may be changed to a new view when the prior view has not changed within a time duration (as reflected in the history data).

In one aspect, the smart camera algorithm comprises a personal camera algorithm, in which one “local” participant is viewing the display data from a first person view. In general, the rules of the personal camera algorithm do not select a view that shows the local participant to himself or herself, except for master establishing shots, or if the local participant is the sole participant.

In one aspect, the smart camera algorithm comprises a producer camera algorithm, in which the local participant appears in a variety of shots. Data corresponding to the view selected by the producer camera algorithm may be recorded for future playback.

In one implementation, the displayed data corresponding to the selected view represents the participant users as avatars. In this implementation, state messages are distributed, from which the position of the avatar (or avatars) in a corresponding frame is able to be re-created. The state messages may include gaze direction data to compute a corrected representation (e.g., a profile view instead of a head-on view) of a participant based on that participant's currently selected view (perceived viewing direction).

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example system in which data is captured and distributed for viewing according to decisions and selections of smart cameras/algorithms.

FIG. 2 is a block diagram representing state message data distributed and stored for later processing for viewing according to decisions and selections of smart cameras/algorithms.

FIG. 3 is a representation of example views of various avatars as seen by users, including a computed profile view that corrects for gaze direction.

FIG. 4 is a block diagram representing received state message data processing for viewing by a personal camera/algorithm, and frame processing performed on captured data to be distributed to other users.

FIG. 5 is a flow diagram representing example steps that may be performed by smart cameras/algorithms.

FIG. 6 is a block diagram representing exemplary non-limiting networked environments in which various embodiments described herein can be implemented.

FIG. 7 is a block diagram representing an exemplary non-limiting computing system or operating environment in which one or more aspects of various embodiments described herein can be implemented.

### DETAILED DESCRIPTION

Various aspects of the technology described herein are generally directed towards providing more professional looking video conferences and the like, along with desirable recording, using a form of artificial intelligence (AI) to operate a “smart camera” (algorithm) that intelligently selects camera views (target subjects, point of view, and/or framing angles) from among multiple physical cameras. In general, a “camera” may refer to a virtual device positioned in the scene that can capture a view from the scene, and is defined by its position, direction and viewing angle (or focal length, which is more or less equivalent to the viewing angle.)

As will be understood, a smart camera comprises one or more algorithms in a system that operate to mediate camera views to facilitate better communication, more intelligently take turns among participants (users), infer correct gaze reference, and/or record multiple participants in a session. The system may use a plurality of inputs including inputs used to detect participant activity by analyzing each participant's captured video, detect other types participant activity such as via “emote” buttons or detected gestures, determine the active speaker or speakers, and input data corresponding to the history of the conference. For example, the active speaker and/or participant activities may be re-evaluated in each frame, with scored assigned scores to each participant.

The system may be used to manage plain video applications, or “virtual” conferences in which users are represented by avatars (animated representatives) in a virtual world. The system may be used in a live video distribution environment and/or may be used to capture recordings, in which the live and/or recorded data may be interacted with by users.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and video processing, recording and/or distribution in general.

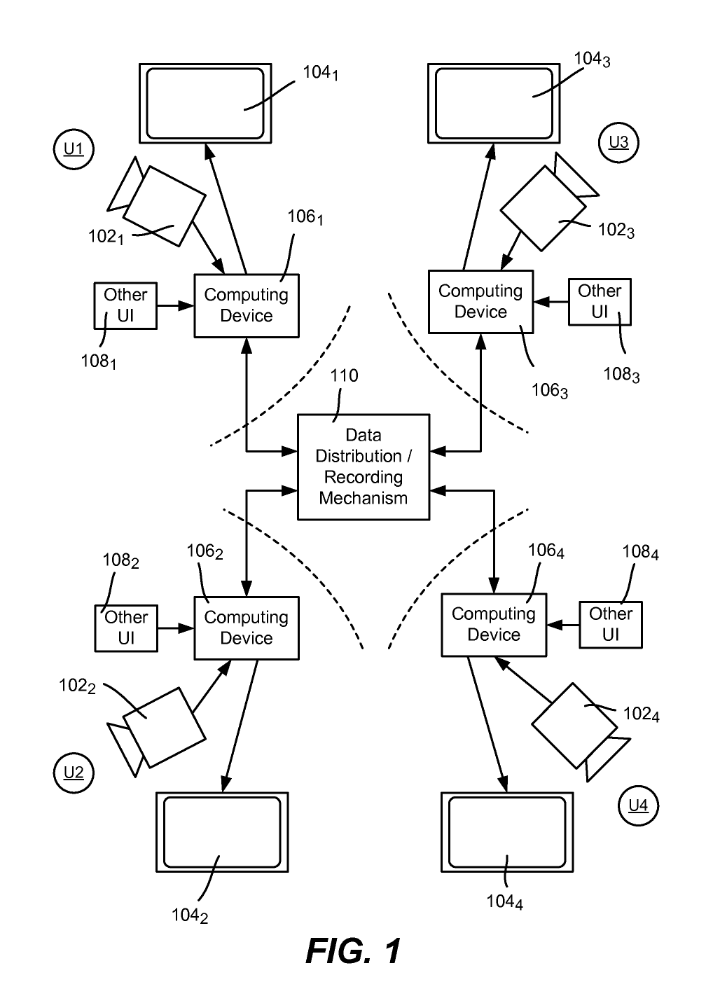

FIG. 1 shows example components of a smart camera system, in which participant users U1-U4 are each positioned in front of a respective physical camera 102₁-102₄ and are each looking at a respective display device 104₁-104₄. Note that while four such “consoles” are represented in FIG. 1, it is understood that any practical number may be present in a given implementation, and that a user may participate without actually needing a display device. Moreover, although not readily apparent from FIG. 1, the participant users U1-U4 may be at remote locations from one another, in the same room as one another (but still considered remote), or some combination of the same room or remote locations. Still further, multiple users may appear in front of a single “local” camera.

In general, each user U1-U4 has a respective computing device 106₁-106₄ that captures the camera's output frames; (note that it is feasible for multiple users, each with their own camera and the like, to share such a computing device). Other user interfaces/input mechanisms 108₁-108₄ are generally present, such as including microphones, keyboards, pointing devices, gaming controllers, and so forth. Examples of suitable computing devices include a personal computer or a gaming console, each of which are already configured to receive camera and other input, and output to a display device; (an Xbox® 360 coupled to a Kinect™ controller/device) is a more specific example. However, other computing devices such as “appliance”-type devices built for video conferencing or the like may be used, and different types of computing devices may be used in the same system.

Each computing device (e.g., 106₁) provides data representative of information captured in the camera frames of the corresponding camera (e.g., 102₁) to a data distribution recording mechanism 110 (e.g., in a cloud service or a computer system), which distributes the data to the other computing devices (e.g., 106₂-106₄) and/or may record the data. Although not explicitly shown, it is understood that any accompanying audio data is also captured and distributed. As will be understood, this distributed data may comprises the information in the video frames themselves (e.g., as is or compressed such as via MPEG technology) or the like. However, as described below, the video information may be very efficiently processed into state messages representative of the frame information that is used to re-create the captured video of the user in the form of a representative avatar in a virtual world. Note that the data distribution recording mechanism 110 need not be centralized as shown in FIG. 1, and indeed may represent peer-to-peer distribution and thus be only a “virtual” distribution mechanism, such as including wired or wireless network/internet connections. If recording is desired in a peer-to-peer environment, one or more of the computing devices needs to assume responsibility of handling the storage.

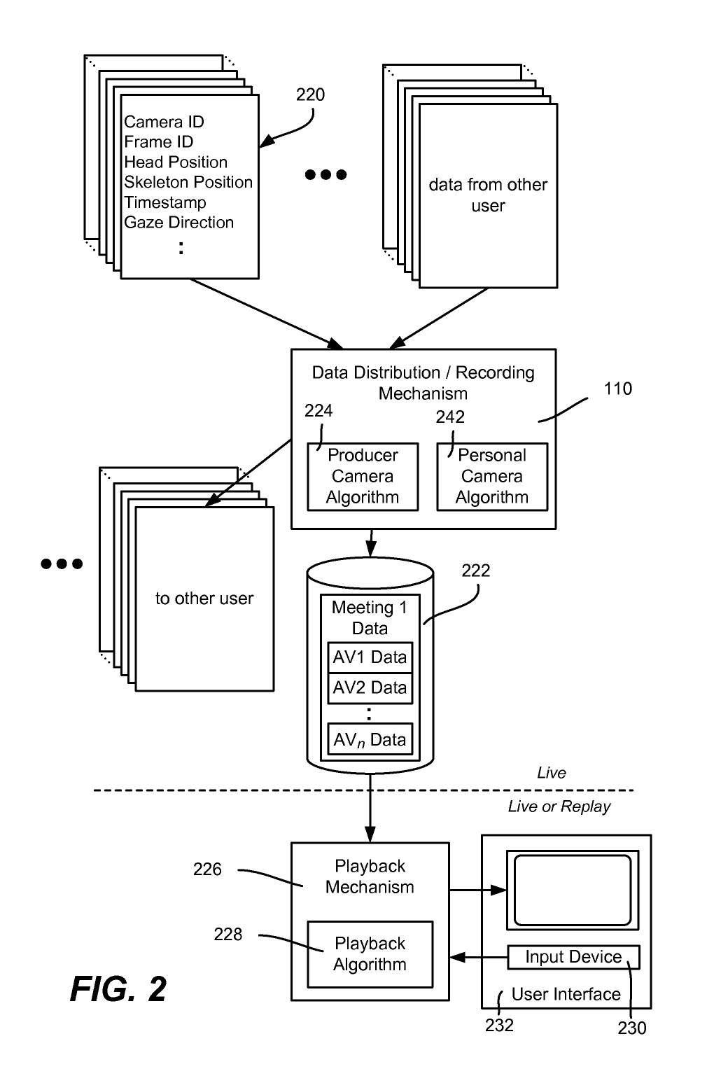

FIG. 2 shows an example of such representative state messages 220 being distributed as data to the various other computing devices. For example, the state message data for a frame may reflect camera ID, frame ID, head position of the user, skeleton position of the user, timestamp, gaze direction and so forth (including audio-related information). This data allows an algorithm or a user to select and view video re-created from the data captured for any user. Effects such as split screen, picture-in-picture and so forth may be used to view the re-created video of multiple users at the same time. Note that in general, a user may see his or her own image/representation as captured by the camera in a small picture-in-picture area on the user's display device.

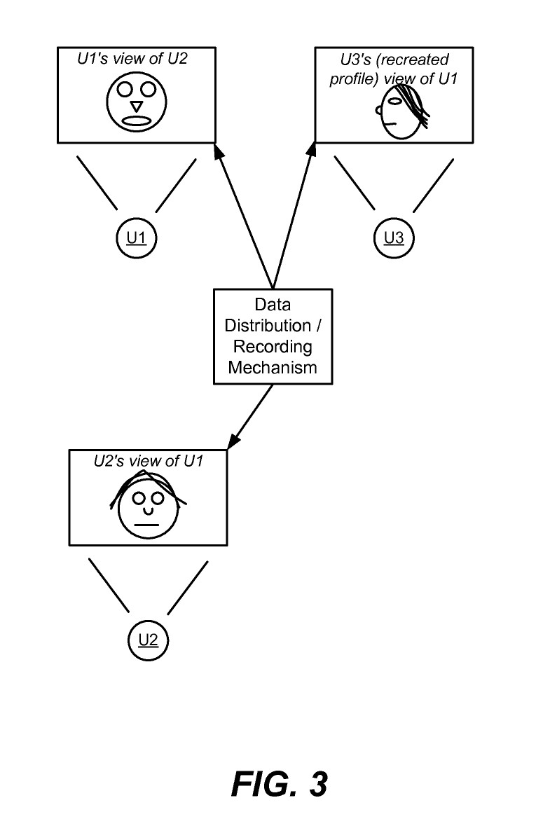

Note that the “gaze direction” data for a frame indicates what the user is looking at in his or her own display as this frame was captured, which may be another avatar or an object in the scene. In general, each user looks directly at his or her camera, and thus without additional processing, each user will appear to face each other user. However, this is unrealistic in many situations. For example, as represented in FIG. 3, consider that users U1 and U2 are currently looking (via algorithmic or user selection) at the videos recreated for each other, such as if U1 and U2 are currently having a conversation. If the user U3 is looking at user U1's representation, and saw user U1 head-on, the user U3 is given the impression that the user U1 is directly facing U3 and thus talking to user U3, when in fact the user U1 is seeing the user U2's representation and is directing the conversation to U2. The gaze direction data distributed for the frame provides U3's computing device 106₃ with the fact that the user U1 is looking at the user U2; thus, the computing device (e.g., its smart camera/algorithm) can perform gaze correction to recreate user U1 as a profile view instead of as a head-on view, whereby user U3 is given the correct impression that user U1 is talking to someone else. In this way, in a virtual world, the view selection for a user drives the orientation of the corresponding avatar's head.

Returning to FIG. 2, also shown is the data distribution/recording mechanism storing the various audiovisual data AV1-AVₙ (e.g., all or some portion of the state messages or the video/compressed video) in a suitable data store 222 for later playback. As described below, a producer algorithm 224 (smart “producer” camera) is configured to select views for the video in a way that generally appears to have been produced by a professional person, e.g., switching between subjects at an appropriate pace, not just based on detected speech or the like, changing point of view, changing framing and so forth. Note that in a peer environment, in which the data distribution/recording mechanism is present on each computing device, a personal camera algorithm 242 (described below) is also present, although not all peers need to perform recording.

Further, a playback mechanism 226 may include a playback algorithm 228 that may be controlled by a input device 230 of a user interface 232, not only for well-known commands such as pause, rewind, fast forward and so on, but for interactive commands such as to manually control the current view being recreated (e.g., show user U1 regardless of the producer algorithm's original choice) and so on. Note that the playback may be time-compressed, sped up, and so forth. Further note that the producer algorithm's output may be viewed (and interacted with) live, such as by a non-conference participant; (although conference participants may similarly run a producer algorithm to switch to see the producer algorithm's selected views).

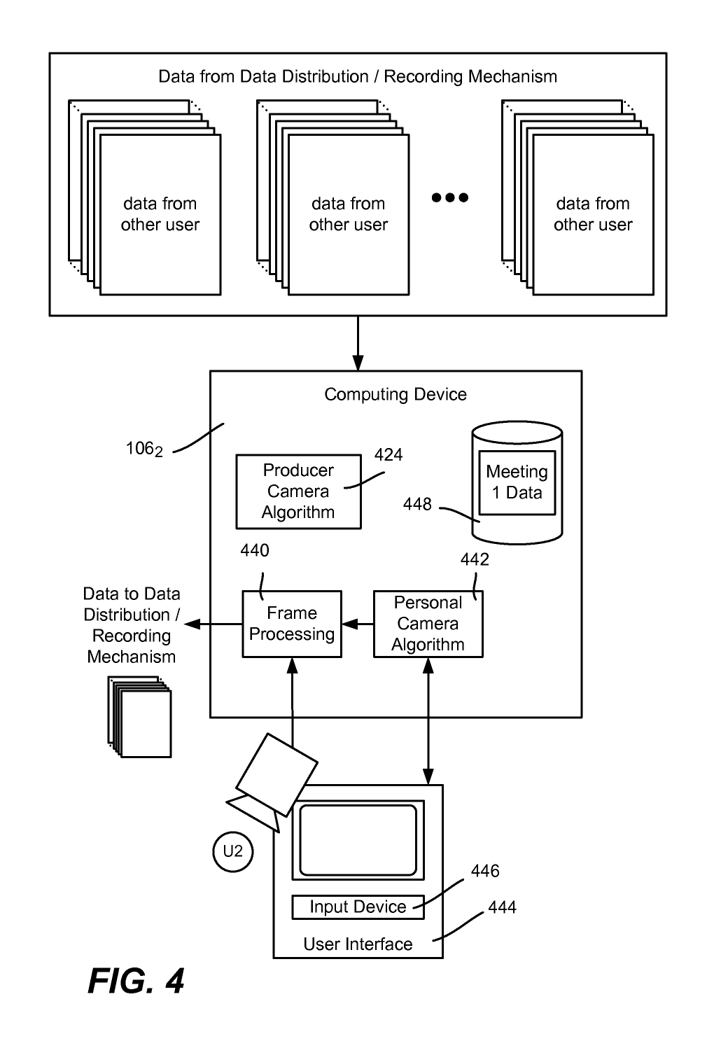

As represented in FIG. 4, each user (e.g., U2) thus has video and typically audio data captured in the computing device (e.g., 106₂). This captured data may be distributed as is or in a compressed form, or as represented in FIG. 4, processed into the state messages (block 440) for animated re-creation as described above.

As also represented in FIG. 4, each user's computing device (e.g., 106₂) includes a personal camera algorithm 442 (smart “personal” camera) that chooses the view for the user (e.g., U2 in this example). Additional details of an example personal camera algorithm 442 comprising rules, data and the like for making its choices are described below, however it is noted that the user may override any choices made by the algorithm via a suitable interactive user interface 444/input device 446. Also, as described above, the user's computing device may include an instance 424 of the producer algorithm, (which may make different choices from the personal camera algorithm 442), and the user can instead choose to see his or her instance of the producer algorithm's choices for viewing and/or interaction. The user may also choose to save a local copy of the received data in a suitable data store 448.

As can be readily appreciated, alternative implementations are feasible. For example, instead of distributing each participant's video-related data (e.g., the state messages or the video/compressed video) to each other participant, where the participant's personal algorithm makes the view selections, the data distribution mechanism can be configured to only distribute the video-related data that a participant needs for viewing at any given time. This may be by communicating from each participant to the distribution mechanism what its personal output algorithm needs (and/or will need next to allow buffering), or by having some or all of the personal output algorithm run on the distribution mechanism (e.g., one instance for each user) so that the personal output algorithm's selection is mirrored at the distribution mechanism. Manual user overrides may be communicated to the distribution mechanism to temporarily change what gets delivered, for example.

Turning to the example algorithms, a general goal is to optimize camera direction for an immersive, first-person 2D or 3D chat or recording experience that is engaging, entertaining, and relatively realistic. As described herein, two different algorithms corresponding to the two different types of smart cameras, personal and producer, generally operate according to two different set of rules.

The personal camera algorithm 442 corresponds to a personal smart camera that displays a scene view to a local participant, with its rules operating to provide a desirable experience for that participant in a primarily first-person view. Most of the time, the personal camera shows a first person view, (the view the user's avatar “sees” when looking at the scene, i.e., a view on the screen that mimics a user's field of view). There may be exceptions, such as switching to a third person view of another camera that captures the whole environment during establishing shots or entrance animations as described below; (where an establishing shot, also called a master shot, refers to third-person camera shot that is generally designed to show all the participants in the scene including the user's avatar within the context of an multiple avatar setting). Using third-person establishing shots, e.g., at the beginning/end of a session when participants enter/exit, helps the user understands his or her relative position in a scene.

The producer algorithm 224 corresponds to a smart producer camera that views the scene primarily for the benefit of future spectators, with its rules operating to provide a desirable experience to future viewers (or non-participating live viewers), using a variety of camera views to mimic the behavior of a skilled technician. In general, the producer algorithm 224 chooses the same views for each participant, so that the recordings of a session from different consoles are all the same (although if the separate video data such as state messages are maintained, a recording may be interacted with for different results, as described above).

In one implementation, these algorithms operate independently and can show different points of view and framing. Each may focus on different participants/avatars/views; for example, when user U1 is speaking, U1's personal camera view shows the other participants/avatars in the room, while the producer camera typically selects a view that shows the user U1 from a third-person point of view. Notwithstanding, as described below, both algorithms/smart cameras follow the same general operations of determining a focus of attention (e.g., a user or object), selecting a point of view, and select a framing.

To select the current view at any time, the algorithms may process various inputs, including inputs to help determine a current speaker or speakers, a level of each user's activity detected by analyzing the participants' videos, skeleton movement and facial activity, and other participant activity such as “emote” buttons or emote gestures, which are used to attract attention or create audio or visual effects; (“emote” generally refers to a special effect that enhances communication through exaggerated behavior and effects). The algorithms may consider both the current and the past values of inputs, e.g. how long has a participant been speaking or how long since someone has been seen, to choose the focus of attention, the point of view of the camera and the framing of the shots. Note that the behavior and framing of the algorithms may depend on the seating configuration of the participants, particularly in the producer algorithm, as described below.

With respect to the personal camera/algorithm, example rules for selecting the focus of attention include that the focus of attention in the personal camera algorithm 442 is not set to the local participant, unless that participant is the only one in the scene; (speaking and emoting do not matter). In general, the focus of attention is the current speaker, unless it is the local participant.

Further, a participant who is the focus of attention keeps that focus for some time (e.g., two seconds minimum; note that such times used herein are examples, and may be user-configurable) to avoid oscillations, even if another participant starts speaking, for example. Also, the focus does not stay constantly on the speaker, even if only one participant is speaking, such that every remote participant is in focus at least some of the time. For example, if a speaker remains active for more than twenty seconds, the algorithm shifts to another focus of attention, even if only briefly.

In general, if a remote participant fires an emote through user input, that remote participant gets the focus of attention. If multiple participants fire emotes, the choice of attention may be random or may shift quickly. As described above, the focus of attention is not affected by the speaking status or emote status of the local participant. Avatars that are not yet participating in the environment, (e.g., are in an off stage or observation area as described below) are not selected as the focus of attention even if they speak or emote.

Framing selection generally refers to the process by which an algorithm (smart camera) selects the direction and angle of view of the camera. One example of a rule for selecting how a scene is framed includes that during a participant's entrance and exit animation, the framing is selected to show the animation in the context of the environment, (assuming a physical camera is present that captures the environment). The framing selection for the personal algorithm attempts provide an immersive experience with an view of the current focus of attention, and (at times) provide a sense of peripheral vision by displaying multiple avatars on screen, while avoid frequent changes of framing that break the immersive experience.

The framing selection rules may include that when the user is the only avatar in the room, the camera stays in a mirror mode shot that contains the user's avatar. Also, during avatar entrances and exits, a corresponding entrance/exit camera is selected, if available. Another example rule is that when there are three or more participants, a “two shot” framing may be selected at times (if available) that encompasses two participants, e.g., the current “primary focus of attention” and another secondary focus. If the secondary focus of attention is seated on the immediate left or right of the primary, then the framing encompasses primary and secondary; in other cases, the framing includes the primary and one of its immediate neighbors.

Still other rules may be used. For example, when there is just one participant on stage, or when the primary has remained constant for more than some length of time (e.g., three seconds), the framing will move to an “intimate” one-shot framing focused on the primary. For long silences or a very active conversation with multiple active speakers, a “Master” shot may be shown for some period of time (e.g., three seconds). Similarly, during transitions, the framing may move to the “Master” shot for a brief duration, before moving to the new selected focus of interest. This may be done when a participant is shown for the first time, for example, in order to keep the user “in the scene.”

If a user fires an emote, the view may switch to a master shot for the duration of the emote. If multiple participants are firing emotes, the framing may stay in the master shot.

With respect to point of view selection, in general, the point of view of the personal camera is set to a first-person point of view; conceptually, the camera looks at the scene through the eyes of the avatar. Exceptions include when a participant enters or exits, in which event the view cuts from first person to the entrance or exit camera, as appropriate. Further, after long silences, or during an active conversation, the view may cut to the master shot. In a monologue (only one avatar) setting, aside from entrance and exit animations, the point of view is set towards the user, providing a “mirror” view.

The user may override the behavior of the personal camera by using an interface device, such as a game controller or keyboard to change focus, move “closer” or “farther” by changing framing, and so on. The smart personal camera behavior may automatically resume after the last user action, such as after ten seconds.

For third person point of view shots, an automatic camera framing algorithm may be applied. For example, once the participants to be framed have been determined, an algorithm that takes as its inputs a desired camera field of view, relative camera height, desired placement of the horizon line in the composition, display device aspect ratio and overscan characteristics calculates camera position, orientation, and lens characteristics to give a pleasant framing. Note that these inputs are provided so that camera behavior is driven using aesthetic terms for camera composition.

The producer algorithm/camera, like the personal camera, operates by first finding the focus of attention for the recording, then selecting a framing and a camera position. Differences from the personal camera include that there is no local participant, that any participant is eligible to become the focus of attention, and that the point of view is selected to provide a desirable experience to a future viewer, instead of preferring the first person view of the user. Also, the point of view is selected as a function of the preferred framing.

The focus of attention for the producer camera is computed using the following rules, namely that in general, the focus of attention is the active speaker, regardless of local/remote considerations, and that a participant who is the focus of attention keeps it for some time, to avoid oscillations. The focus does not stay constantly on the speaker, and every participant is in focus at least some of the time. Participants that are not currently in the environment are not selected as the focus of attention, even if they speak or emote. Note that the timing data as to when to switch focus may be the same as for the personal camera, but may be different for any or all times, and may be configurable.

The framing selection for the producer camera is generally similar to that of the personal camera, and is designed to provide a pleasant cinematic experience for the viewer of the recording. The framing selection applies similar rules, which are not again described, however it should be noted that alternatives are feasible, and timing, transitions and so forth may differ from the personal view to provide a desired effect.

In general, the point of view selected for the producer camera depends on the seating configuration and the choice of framing. The following table provides guidelines for selecting a point of view as a function of seating configuration:

| Name | One-Shot | Two-Shot | Master-Shot |
|---|---|---|---|
| Circle/ | In front of the | Outside of the circle, | Up and above, so |
| Conversation | avatar, at | diametrically | the entire circle |
| Pit | correct distance | opposed to the | is in the field |
| | for one-shot | midpoint between | of view. |
| | framing. | the two avatars. | |
| Monologue | In front of the | N/A | In front of |
| | avatar, at | | the avatar, at |
| | correct distance | | sufficient distance |
| | for one-shot | | to capture the |
| | framing. | | full avatar body. |
| Talk Show | In front of the | In the line that | In front of the |
| | avatar, at | bisects the positions | seating |
| | correct distance | of the avatars, at | configuration, |
| | for one-shot | adequate distance | capturing the 4 |
| | framing. | for two-shot framing | seats. |
| Intimate | In front of the | In the line that | In front of the |
| | avatar, at | bisects the positions | seating |
| | correct distance | of the avatars, at | configuration, |
| | for one-shot | adequate distance | capturing the 2 |
| | framing. | for two-shot framing. | seats. |

For each seating configuration, camera shots may be dynamically generated to show the possible one-shot and two-shot views. These cameras have a fixed point of view and framing which are determined programmatically. In addition, a set of third-person environment cameras are defined to which the smart camera can switch during certain events for the master shots. These may be placed to show the best overview of a scene. For an entrance, the camera may move along a predefined path.

Various rules may apply to what is shown. For example, in a one-shot framing, the selected subject may be framed vertically on the center of the screen, with the horizon line below the eyes. The eyes are approximately located on the horizontal top third of the screen. The height of the head may be approximately one half of the height of the screen. The camera may be directed towards the “nominal” position of the avatar. If the avatar moves its head, the camera does not track, allowing the head to move on screen.

In a two-shot example, if there are three or more participants in the room, the camera's field of view encompasses two participants. The framing is such that the “primary” avatar is placed on the left or right third of the screen, depending on where the avatar is in relation to the user. The eyes of the primary participant fall on the top third of the screen. The angle of view is wide enough to show the second avatar in the picture

By way of example of some meeting/conferencing scenarios, consider a user that first goes into a virtual offstage area (where the user can practice, rehearse, and/or wait for a cue) before joining other participants in a main environment. In this state, the user may see a preview of a selected, themed environment. When the user enters the environment, the user sees an image of his avatar entering, and then switches to a personal viewpoint. As others join, the point of view shifts to see the others enter the scene, then moves to a first-person point of view that shows a close-up of the other' avatars, for example. As each one talks, the point of view stays in the first person, but the view shifts to encompass whoever is talking or emoting. The others see the screen shots selected by their respective personal cameras. Each player sees a different view, as selected by his or her camera. Users can also see an image of themselves in a picture-in-picture view.

By way of another example, consider a user making a monologue (only one avatar) recording. Movements in the selected environment are mirrored to the user; note that picture-in-picture is off by default in this mode. On playback, the user is sees the movements from the audience's point of view, so that they appear reversed relative to the mirror view.

Another example is a multiple participant recording, with two participants present at the start, and another coming into the environment midway through the recording by watching offstage and entering when she hears her cue. Each participant sees the other participants in a close-up first person point of view during the recording. The active participants see the screen shots selected by their personal camera, that is, each participant sees a different view, as selected by his or her own personal camera. Upon playback, they are seen together in a third person point of view, with the camera shifting so the active speaker is generally in view, that is, the producer smart camera selects the positions and framing according to its rules, and the corresponding events are captured in the recording, and output (e.g., sent over the network to the participants and any others).

In this manner, the smart camera technology supports meeting other game players or meeting participants “face-to-face” as avatars, recording movies in single-person monologue scenarios, and recording movies with multiple participants.

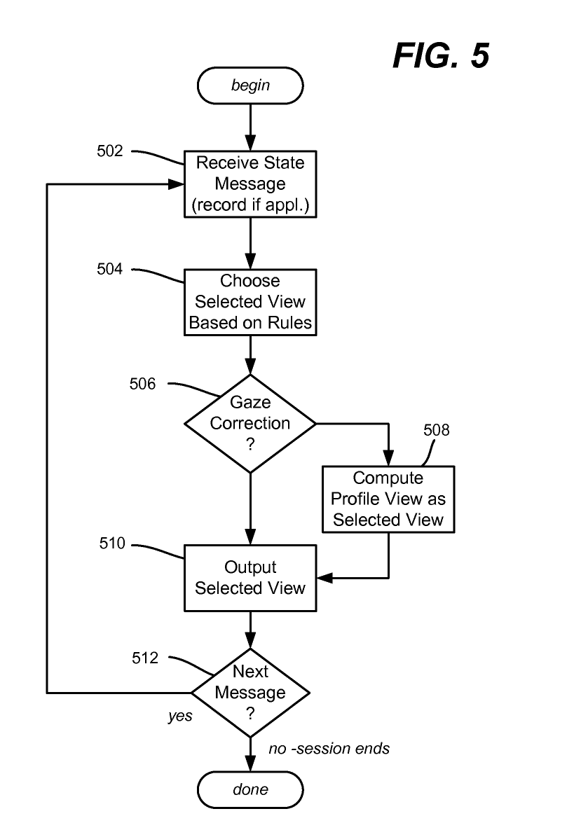

FIG. 5 shows example steps of a smart camera in an avatar scenario, beginning at step 502 where a state message is received. The state message may be recorded for later playback if desired.

Step 504 represents applying the algorithm rules to choose a selected view. As described above, this may be based upon history, timing, participant activity and so forth. Step 506 evaluates the state message data to determine whether gaze correction is required. If so, step 508 is performed to compute a profile view (or possibly another view, such as the back of the avatar's head if directly gazing away).

Step 510 represents outputting the selected view. The process repeats (step 512) for each state message received until the session ends.

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

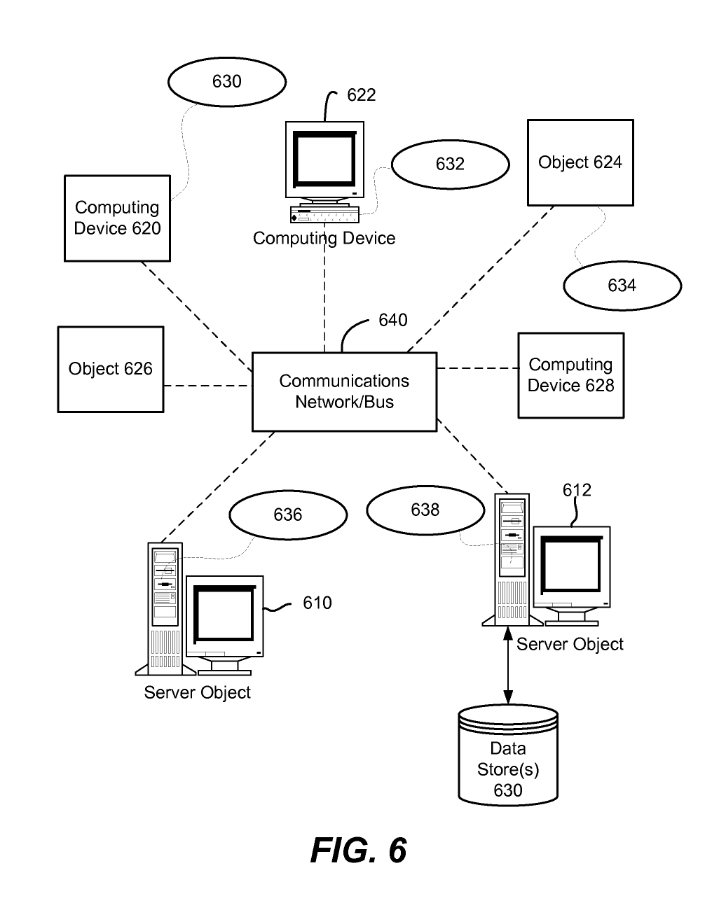

FIG. 6 provides a schematic diagram of an exemplary networked or distributed computing environment. The distributed computing environment comprises computing objects 610, 612, etc., and computing objects or devices 620, 622, 624, 626, 628, etc., which may include programs, methods, data stores, programmable logic, etc. as represented by example applications 630, 632, 634, 636, 638. It can be appreciated that computing objects 610, 612, etc. and computing objects or devices 620, 622, 624, 626, 628, etc. may comprise different devices, such as personal digital assistants (PDAs), audio/video devices, mobile phones, MP3 players, personal computers, laptops, etc.

Each computing object 610, 612, etc. and computing objects or devices 620, 622, 624, 626, 628, etc. can communicate with one or more other computing objects 610, 612, etc. and computing objects or devices 620, 622, 624, 626, 628, etc. by way of the communications network 640, either directly or indirectly. Even though illustrated as a single element in FIG. 6, communications network 640 may comprise other computing objects and computing devices that provide services to the system of FIG. 6, and/or may represent multiple interconnected networks, which are not shown. Each computing object 610, 612, etc. or computing object or device 620, 622, 624, 626, 628, etc. can also contain an application, such as applications 630, 632, 634, 636, 638, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 6, as a non-limiting example, computing objects or devices 620, 622, 624, 626, 628, etc. can be thought of as clients and computing objects 610, 612, etc. can be thought of as servers where computing objects 610, 612, etc., acting as servers provide data services, such as receiving data from client computing objects or devices 620, 622, 624, 626, 628, etc., storing of data, processing of data, transmitting data to client computing objects or devices 620, 622, 624, 626, 628, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 640 or bus is the Internet, for example, the computing objects 610, 612, etc. can be Web servers with which other computing objects or devices 620, 622, 624, 626, 628, etc. communicate via any of a number of known protocols, such as the hypertext transfer protocol (HTTP). Computing objects 610, 612, etc. acting as servers may also serve as clients, e.g., computing objects or devices 620, 622, 624, 626, 628, etc., as may be characteristic of a distributed computing environment.

### Exemplary Computing Device

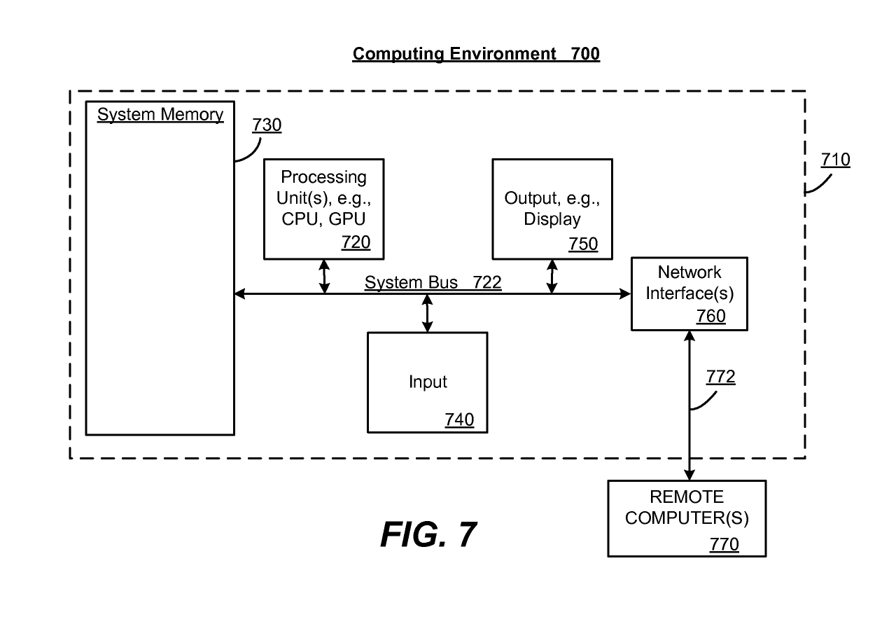

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 7 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 7 thus illustrates an example of a suitable computing system environment 700 in which one or aspects of the embodiments described herein can be implemented, although as made clear above, the computing system environment 700 is only one example of a suitable computing environment and is not intended to suggest any limitation as to scope of use or functionality. In addition, the computing system environment 700 is not intended to be interpreted as having any dependency relating to any one or combination of components illustrated in the exemplary computing system environment 700.

With reference to FIG. 7, an exemplary remote device for implementing one or more embodiments includes a general purpose computing device in the form of a computer 710. Components of computer 710 may include, but are not limited to, a processing unit 720, a system memory 730, and a system bus 722 that couples various system components including the system memory to the processing unit 720.

Computer 710 typically includes a variety of computer readable media and can be any available media that can be accessed by computer 710. The system memory 730 may include computer storage media in the form of volatile and/or nonvolatile memory such as read only memory (ROM) and/or random access memory (RAM). By way of example, and not limitation, system memory 730 may also include an operating system, application programs, other program modules, and program data.

A user can enter commands and information into the computer 710 through input devices 740. A monitor or other type of display device is also connected to the system bus 722 via an interface, such as output interface 750. In addition to a monitor, computers can also include other peripheral output devices such as speakers and a printer, which may be connected through output interface 750.

The computer 710 may operate in a networked or distributed environment using logical connections to one or more other remote computers, such as remote computer 770. The remote computer 770 may be a personal computer, a server, a router, a network PC, a peer device or other common network node, or any other remote media consumption or transmission device, and may include any or all of the elements described above relative to the computer 710. The logical connections depicted in FIG. 7 include a network 772, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising:
receiving data corresponding to video data captured from a plurality of participant cameras;
providing the data to an algorithm comprising a set of rules for selecting a view corresponding to camera selection and framing selection, or camera selection, framing selection and point of view selection;
choosing a selected view via the algorithm; and
outputting display data corresponding to the selected view.

2. The method of claim 1 wherein the algorithm comprises a personal camera algorithm, wherein one participant is viewing the display data, and wherein choosing the selected view comprises selecting a first person view of another participant based upon participant activity and history data.

3. The method of claim 1 wherein the algorithm comprises a producer camera algorithm, and wherein choosing the selected view comprises selecting a third person view based upon participant activity and history data.

4. The method of claim 3 further comprising, recording data corresponding to the view selected by the producer camera algorithm for future playback.

5. The method of claim 1 wherein outputting the display data corresponding to the selected view comprises representing a participant user as an avatar.

6. The method of claim 5 wherein receiving the data corresponding to the video data comprises receiving a state message comprising information from which position of the avatar in a corresponding frame is able to be re-created.

7. The method of claim 1 wherein choosing the selected view comprises selecting the view based upon history data, including changing a prior view to a new view when prior view has not changed within a time duration.

8. The method of claim 1 wherein choosing the selected view comprises selecting a view based upon participant inactivity.

9. The method of claim 1 wherein choosing the selected view comprises selecting the view based upon a participant speaking, emoting, moving, gesturing, entering an environment, or exiting an environment.

10. The method of claim 1 wherein choosing the selected view comprises varying the framing from a previous view to the selected view to change perceived closeness of a camera shot, to change from a one participant view to a two participant view, or to change to a master view showing all participants present in an environment.

11. The method of claim 1 wherein outputting display data corresponding to the selected view comprises using gaze direction data to compute a corrected representation of a participant based on that participant's currently selected view.

12. In a computing environment, a system, comprising:
a plurality of cameras, each camera configured to capture video data representing at least one participant; and
at least one computing device coupled to the cameras, each computing device configured to output video frames representative of selected views of one or more of the participants based upon view selections made by a smart camera algorithm associated with that computing device, in which the smart camera algorithm makes a view selection for each output data frame based upon participant activity and history.

13. The system of claim 12 wherein a plurality of computing devices are each running a smart camera algorithm, and further comprising a data distribution mechanism configured to receive video-related data corresponding to the captured video data from each computing device, and to distribute at least some of the video-related data from each computing device to each other computing device.

14. The system of claim 12 wherein the smart camera algorithm on at least one computing device comprises a personal camera algorithm or a producer camera algorithm.

15. The system of claim 12 wherein the smart camera algorithm comprises a producer camera algorithm, and further comprising means for playing back the selected views of the producer camera algorithm.

16. The system of claim 12 wherein the data corresponding to the captured video comprises a state message including head position data and skeleton position data by which an avatar representative of a participant may be positioned in at least some of the output data frames.

17. The system of claim 12 wherein the data corresponding to the captured video comprises a state message including gaze direction data by which an avatar representative of a participant may be computed to appear to be looking in a direction that is based upon the gaze direction data.

18. One or more computer-readable media having computer-executable instructions, which when executed perform steps, comprising:
(a) receiving state messages, including state messages comprising data representative of original video frames of participants captured by cameras;
(b) selecting a selected view based upon participant activity and available history;
(c) processing a state message corresponding to the selected view to re-create a virtual video frame that is a representation of the original video frame associated with that state message;
(d) outputting the virtual video frame; and
(e) returning to step (a) during a session to provide a representative video clip of the original video frames that varies the selected view based upon the participant activity and available history.

19. The one or more computer-readable media of claim 18 having further computer-executable instructions comprising, recording information by which the representative video clip may be played back.

20. The one or more computer-readable media of claim 18 wherein selecting the selected view comprises choosing a camera selection, framing selection and point of view selection.
